(19) United States
(12) Patent Application Publication
(10) Pub. No.: US 2011/0099468 A1
(43) Pub. Date: Apr. 28, 2011

(54) DOCUMENT DISPLAY SYSTEM

(76) Inventor: Braddock Gaskill, South Pasadena, CA (US)

(21) Appl. No.: 12/603,783

(22) Filed: Oct. 22, 2009

(51) Int. Cl. G06F 17/00; G06F 3/048

(52) U.S. Cl. 715/240; 715/853

(57) ABSTRACT

A document display system and method for enhancing the effectiveness of a user interface includes one or more tiles, a spatial modifier, and a variable display region. Document data of multiple abstraction levels is obtained and represented at one of the abstraction levels in a document representation within a variable display region of the tile. The tile can be spatially modified by position and dimension having a tile position and tile dimensions. Upon escaping a particular range of tile dimensions, the document representation alters the abstraction level portrayed therein.

### FIELD OF THE INVENTION

The present invention relates to the field of data arrangement and more specifically to the field of graphical user interfaces.

### BACKGROUND

A growing number of individuals, businesses, and government agencies rely on computer and electronic technologies to create, store, analyze, and retrieve information such as documents, data and/or images. Presenting the information by outputting requested documents, data, and/or images to a user is increasingly important for efficient sifting, navigation and analysis of the information. Several standard models of document layout are currently in use. One example of a document layout is a list layout that sorts the documents according to set criteria and outputs brief summaries for each document in a list order. This is the type used by many of the internet search engines, such as Google®. Another model is a tree map that lays out the documents in a grid of squares that are interrelated to one another. U.S. Pat. No. 6,879,332 B2, for example, discloses a user interface that displays a hierarchy of information using a plurality of nodes.

Present document layout models have several drawbacks. A significant drawback is the model's inability to use the available space on a screen efficiently. Furthermore, the information is often not presented in a manner consistent with how humans cognitively learn, organize, and retrieve information. These drawbacks may increase the amount of time, effort, and money a user must expand in order to find the pertinent document. There is a need for a document display system that provides efficient visualization and/or manipulation of information.

Therefore, there is a need for a document display system having an efficient means for spatially altering a document or its contents using a conventional rectangular text rendering algorithm or subroutine; that allows a space-efficient and natural means to visually separate the text of adjacent tiles; and that allows the maximum number of neighbors for each document possible in a homogeneous grid.

### SUMMARY

The present invention is directed to a document display system and method. The document display system includes one or more tiles, a spatial modifier, and a variable display region. The tile has tile dimensions and a tile position. A spatial modifier acts to alter the tile dimensions, e.g. by panning, and the tile position, e.g. by scrolling either vertically or horizontally. Within each tile exists the variable display region. The variable display region displays a document representation, which may include one of multiple varieties of document abstraction levels. Each document representation derives from a document having document data. Dependent upon the tile dimensions, the document representation varies in its information abstraction level.

A method of displaying documents of the present invention includes obtaining document data having at least two levels of information abstraction. The document data is represented in a document representation within a visual tile. The tile has a tile position and tile dimensions, and may be spatially modified in depth or position. As the tile dimensions are modified, the document representation changes between the levels of information abstraction.

A preferred method of displaying documents includes obtaining document data for multiple documents having at least two abstraction levels. The document data is represented in a document representation enclosed within a hexagonal tile having a tile position and tile dimensions. Among regular geometric shapes, a hexagonal tile is a preferred means of display as the hexagonal perimeter maximizes the number of tile neighbors possible within a homogenous grid. Neighboring relationships may represent important visual data, as the preferred method further sequences the hexagonal tile based on interrelated document data.

Therefore, it is an aspect of the present invention to present a document display system having an efficient means for spatially altering a document or its contents using a conventional rectangular text rendering algorithm or subroutine.

It is a further aspect of the present invention to present a document display system that allows a space-efficient and natural means to visually separate the text of adjacent tiles.

It is a further aspect of the present invention to present a document display system that allows the maximum number of neighbors for each document possible in a homogeneous grid.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 is a flowchart view of an embodiment of the method of the present invention.

FIG. 2 is a representation of an embodiment of the system of the present invention.

FIG. 3 is a representation of an embodiment of the system of the present invention.

FIG. 4 is a representation of an embodiment of the system of the present invention.

FIG. 5 is a representation of an embodiment of the system of the present invention.

FIG. 6 is a flowchart view of an embodiment of the method of the present invention.

FIG. 7 is a representation of an embodiment of the system of the present invention.

FIG. 8 is a representation of an embodiment of the system of the present invention.

FIG. 9 is a representation of an embodiment of the system of the present invention.

FIG. 10 is a representation of an embodiment of the system of the present invention.

FIG. 11 is a representation of an embodiment of the system of the present invention.

FIG. 12 is a representation of an embodiment of the system of the present invention.

### DETAILED DESCRIPTION

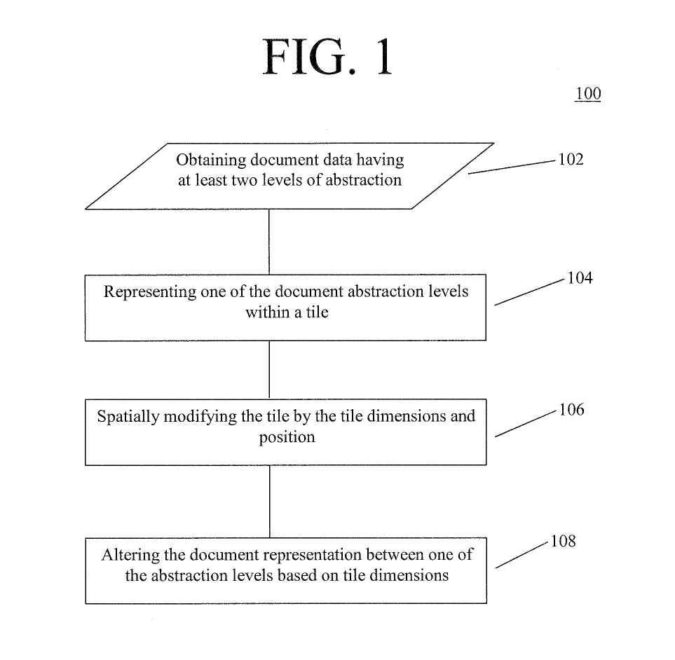

Referring first to FIG. 1, a basic embodiment of the method of displaying documents 100 is shown. The document display method 100 includes the step of obtaining 102 document data having at least two abstraction levels. The document data derives from the content of machine readable documents; documents suitable for use by the present method include any machine readable document bearing visible, language data. Examples of suitable documents include MS WORD documents, portable data files, hypertext markup language, rich text formats, plain text formats, and the like.

The document includes within its document data at least two levels of abstraction. By levels of abstraction, it is meant that the document includes two varieties of information, preferably of differing levels of informational specificity, relating to a single content source. A prime example of a document having multiple levels of abstraction includes scientific papers; a scientific paper will generally include at the highest level of abstraction: a title; at a second, lower level of abstraction: an abstract; and at the lowest level of abstraction: the scientific findings. Each level of abstraction relates to the document data, but each level of abstraction present the data related to a single source on separate levels of informational specificity.

Upon obtaining document data, the method 100 represents 104 one of the levels of abstraction in a document representation within a tile. The document representation is the portion of the tile that displays the level of abstraction relating to the document data. The tile has both a tile position and tile dimensions. The modifying 106 step of the present invention allows the tile position and the tile dimensions to be spatially modified. That is to say, in modifying the tile a user may scroll the position of the tile horizontally or vertically relative to the view screen. The tile dimensions may be modified as a user pans (i.e. zooms) in and out relative to the tile.

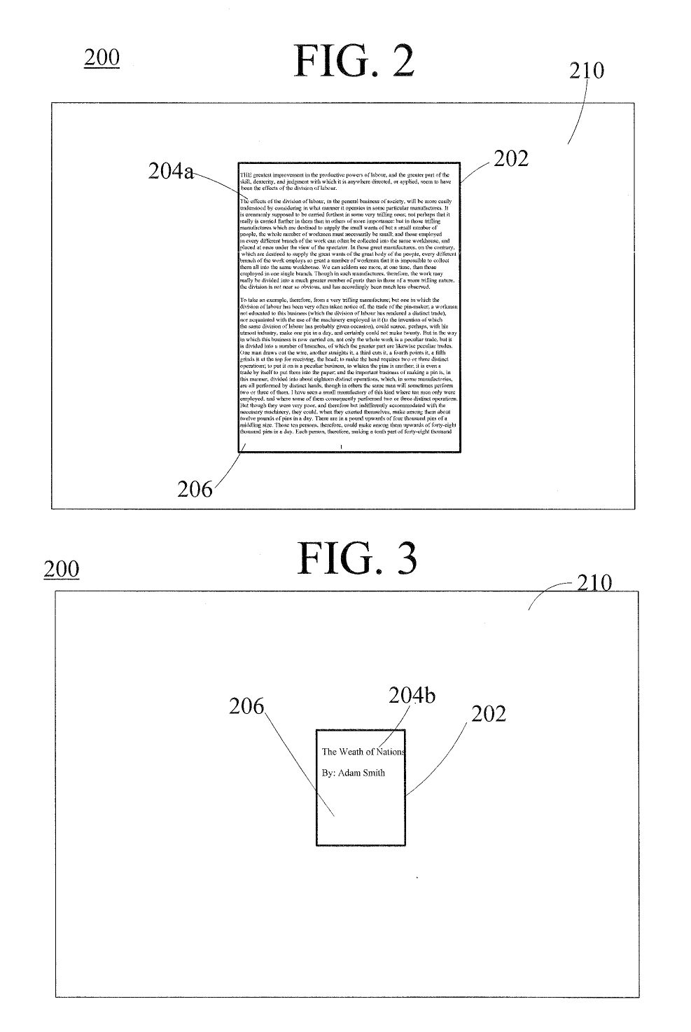

The document representation is altered 108 between abstraction levels based on the tile dimensions. In altering the document representation, it is preferred that each level of document data information abstraction be assigned a pre-set range of values corresponding to the dimension of the tile. Upon surpassing or descending from the pre-set range of values, the document representation would then alter to a second level of document data information abstraction. It is preferred that smaller dimensions trigger the method 100 to display the data of higher abstraction, while conversely, larger tile dimensions trigger the to method 100 to display the data of lower abstraction. FIG. 2, which depicts the system 200 of the present invention, shows a view screen 210 displaying the tile 202 defining an interior display region supporting a document representation 206 portraying document data 204a of a low abstraction level—shown here as Adam Smith's The Wealth of Nations. As a user opts to pan out to shrink the dimensions of the tile 202 within the view screen 210, as shown in FIG. 3, the document representation 206 alters to display document data of a different level of abstraction 204b, shown here as the title of Adam Smith's great work.

The present invention is not tied to any particular dimensions that initiate the change between abstraction levels; it is, however, preferred that the abstraction levels change at a point from a lower level of abstraction to a higher level of abstraction when the lower level of abstraction becomes illegible to a target user. Similarly, it is preferred that in increasing the dimensions of the tile, that the document representation alters from a level of abstraction to a lower level of abstraction as the document data of the lower level of abstraction becomes legible to a target user in the contemporaneous tile dimensions.

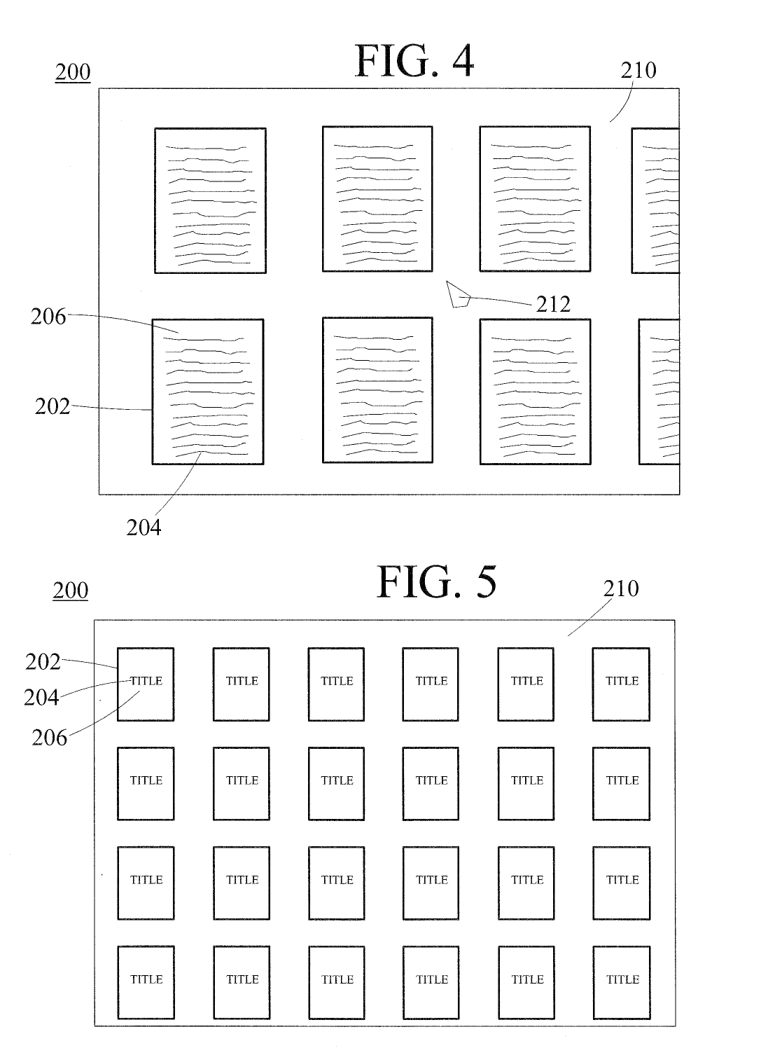

As is shown in FIG. 4, the present invention allows a user to efficiently view multiple documents, within the tiles 202, upon a single view screen 210. A user may utilize a spatial modifier, shown here as a pointer 212, to reposition the frame within the view screen 210 to allow the user to view one or more documents of choice. Although the visual indicator of a pointer, as originate from computer input devices such as a mouse or track ball, will often be capable of horizontal and vertical adjustment of a screen; the system 200 must be capable of modification by depth. In modifying the system 200 in depth, it is preferred that the track wheel of a mouse or track ball be initiated to alter the depth of the view screen to adjust the dimensions of the tile 202. In attempting to locate another document or set of documents having a subject matter, the user may pan out to view the documents within the view screen 210 at a second level of abstraction (e.g. a title) more amenable to rapid scanning, as FIG. 5 shows.

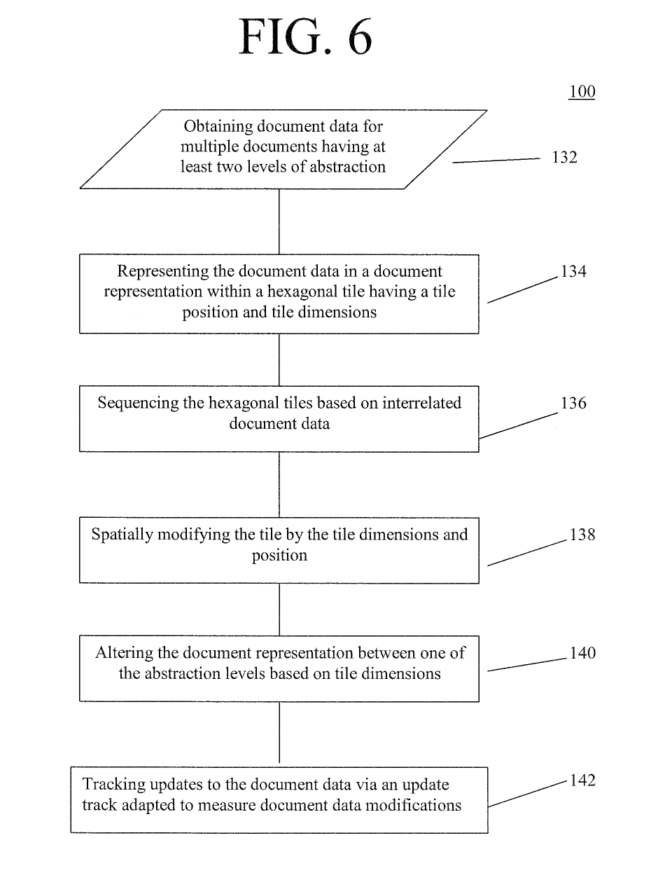

A preferred implementation of the present invention is depicted in the method of displaying a document 100 of FIG. 6. The method 100 obtains 132 document data from multiple machine readable documents provided or specified to the system. The document collection could include a user's explicit selection one or more locally stored files, documents stored over a network, web pages via a mechanism such as a uniform resource locator, a user-initiated search using an external search engine such as GOOGLE, or the like. This collection of documents may also be assembled by other general control logic, such as a mechanism which retrieves documents based upon a database of documents similar to documents which the user already requested. The present invention, however, is not meant to be limited to any specific, present or future machine readable documents; the sole limitation is that the documents include machine readable, visible language or pictorial data.

The machine readable document is read into the system via a parser which recognizes its specific machine readable format, as is commonly understood in the field. A parser recognizes structure, formatting, and content encoding and produces a corresponding document model within a memory. The method 100 then represents 134 the document in a document representation. The document representation step 134 accepts as input the document model, view port parameters, and a region size metric, and generates a document representation appropriate to the region size and view port parameters. A view port, in the context of this disclosure, is an area of a representation of a rendered document. In the most common case, this could be a rectangular area of a 2D raster image which contains a rendering of a document's text. In a trivial implementation, this stage simply uses the original document model with no modification as the new document representation.

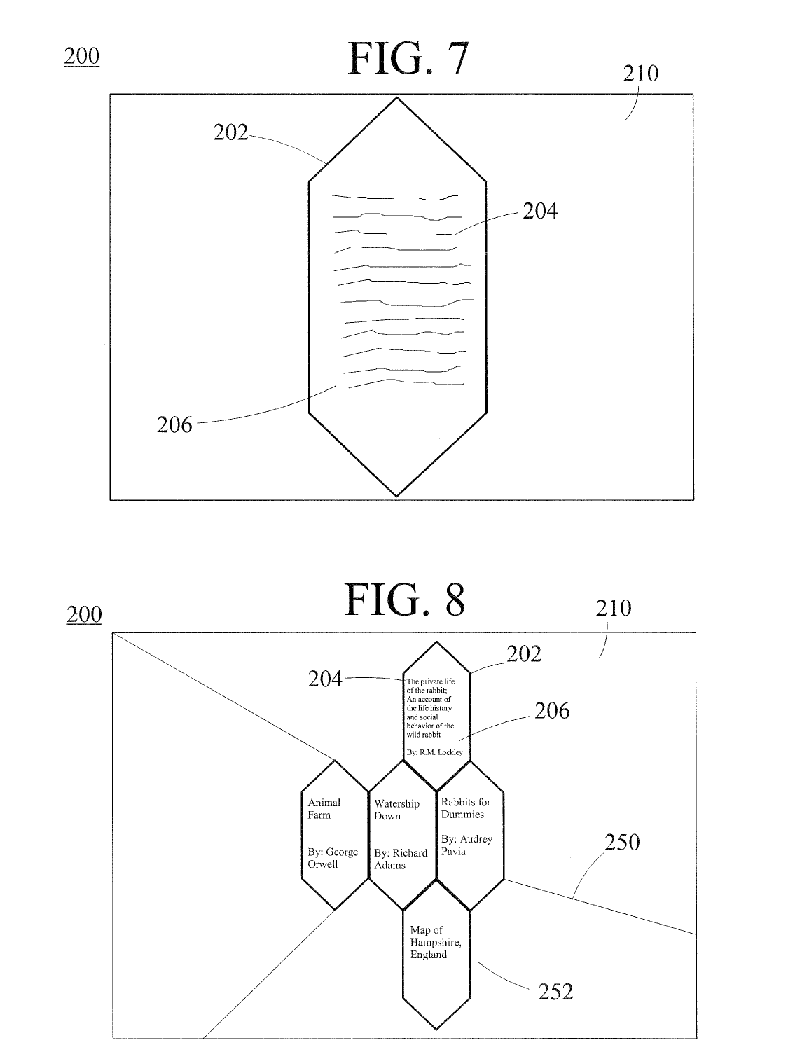

View port parameters are the numeric parameters which define a view port. In a trivial case, they may comprise two numbers which measure the offset into a 2-dimensional raster image of the top left-hand corner of a rectangular view port, and two additional numbers which measure the width and height in pixels of the view port into the raster. However, view port parameters may also be measured relative to positions within a document, such as the view of a particular paragraph, instead of being indexed into a particular raster rendering of that document. As shown in FIG. 7, it is preferred that the document representation 206 having document data 204 be encapsulated within a hexagonal tile 202 having tile dimensions and a tile position. As an example the document data may be a text file of Richard Adam's Watership Down.

Returning to FIG. 6, the method 100, having previously accessed the document data for multiple machine readable documents in the obtaining 132 step of the present invention, sequences 136 the hexagonal tiles based on interrelated document data. An example of sequencing results is depicted in FIG. 8. The present invention scans the document data using known means of related document data to ascertain related documents and files, and then sequences those related documents in a position related to a particular relationship. Continuing with the Watership Down example, the present invention may scan the work for internal citations and position the work of R. M. Lockley northeast (by the figure) and directly proximate to the Watership Down file. The present invention may scan for documents and files related to the different themes of Watership Down to discern the themes of rabbits and use of animals in political commentaries and respectively sequence Audrey Pavia's Rabbits for Dummies east (by the figure) and George Orwell's Animal Farm west (by the figure) in relationship to Watership Down. The present invention may further scan the document data of Watership Down to sequence more practical information, such as a map of Hampshire, England southeast (by the figure) thereof.

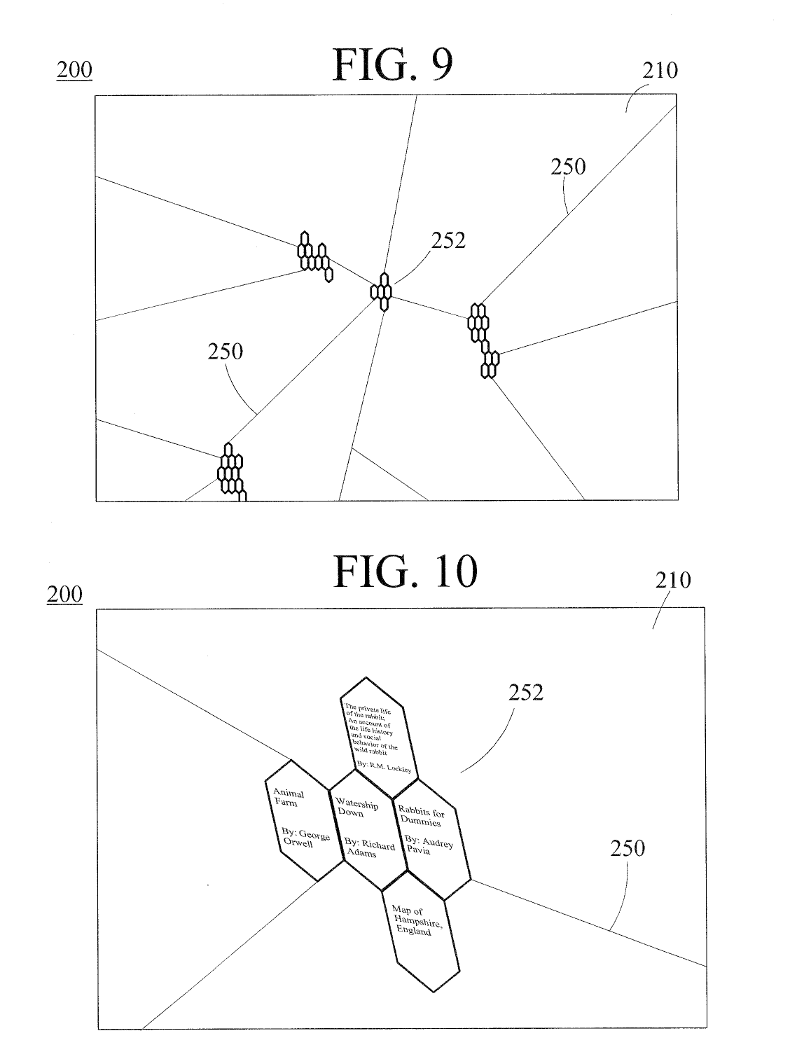

The collected documents may include multiple levels of interrelationship. At one level of close interrelationship the present invention may sequence related documents based on their respective document data into document clusters 252. These document clusters 252 include document representations 206 within hexagonal tiles 202. Documents having document data 204 of lesser relationship may be positioned in lesser proximity to the documents with which the relationship is shared. As FIG. 9 illustrates, in such situations it is preferred that the relationship be visually established by the presence of a node line 250. The node lines allow a user to visually follow the relationship to the document data of other documents. Each cluster 252 may lead to other clusters 252, which in turn are connected by node lines 250 to other clusters 252.

Returning to FIG. 6, the user may spatially modify 138 the tile(s) by position and depth. The preferred means for repositioning the tile includes altering the viewable region of a view screen 210 rather than manipulating a single tile. That is to say, tiles do not move; the position from which a user views the tile is relocated. The preferred means for relocating the view of tile(s) includes by position and depth. Other preferred means for relocating the view of a tile in a 3-dimensional space includes tilting. As FIG. 10. shows, 3-dimensional navigation through the clusters 252 may be greatly aided by the ability to rotate the viewable region of the view screen 210.

Returning to FIG. 6, the document representation within tiles alters 140 between the various abstractions of the document data within the documents. This is not to say that all documents collecting in the obtaining step 132 are required to include multiple levels of abstraction, but a substantial number of documents include multiple levels of abstraction. It is preferred that at least two documents include multiple levels of abstraction. It is preferred that smaller dimensions trigger the method 100 to display the data of higher abstraction, while conversely, larger tile dimensions trigger the method 100 to display the data of lower abstraction.

The levels of abstraction will depend on the documents according to the method. The document data of the present invention will include at least two levels of abstraction, although these documents having this document data may be intermingled with documents having a single level of document abstraction. The abstraction level of the document data may include for example: the natural document data, a document title, a section title, a chapter number, an abstract, a summary, a key word representations and summaries, conclusions, and other means for representing a document using less than the entirety of the document. The present invention may utilize at least two abstraction levels, but may include as many levels of abstraction—each present in a particular range of tile dimensions—as desired to effectively implement the present invention.

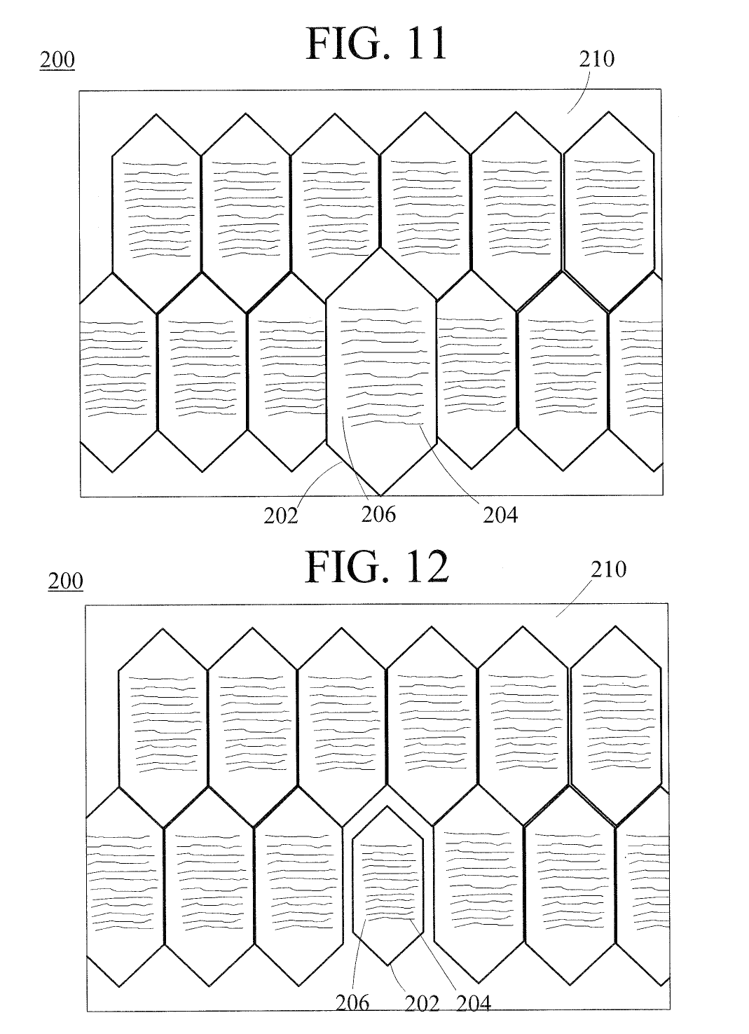

As FIG. 6 shows, the present invention further tracks 142 the document data of the documents. Upon noting an alteration or change in the document data of the document, the present invention may further alter a visual representation of a tile or its document representation in order to alert a user to the change of document data. As FIGS. 11 and 12 show, one preferred means of visual representation alteration includes altering the size of the document representation and the tile dimensions having its document data altered. The tile dimensions may be increased, decreased, or a combination of the two to promote a flashing effect. A further visual representation alteration includes altering the color of the document representation by either altering the color of the document data of a particular abstraction level, or simply altering the color tint of the document representation within the tile.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A document display system comprising:
a tile having tile dimensions and a tile position;
a spatial modifier adapted to alter said tile dimensions and said tile position; and
a variable display region, within said tile dimensions, adapted to portray a document representation having document data with multiple document abstraction levels, wherein said document representation alternates between said document abstraction levels dependant upon said tile dimensions.

2. The system of claim 1 further comprising a tile cluster of multiple tiles, at least two of which are spatially adjacent.

3. The system of claim 2 wherein said tile dimensions include a hexagonal perimeter.

4. The system of claim 2 wherein at least two tiles of said tile cluster include interrelated document data.

5. The system of claim 4 wherein said document data includes at least a document title and document text.

6. The system of claim 5 wherein said tile dimensions include a hexagonal perimeter.

7. The system of claim 6 further comprising an update track adapted to measure modifications to said document data.

8. The system of claim 7 wherein said tile dimensions are adapted to alter based on said update value.

9. The system of claim 8 wherein said variable display region is adapted to visually alter based on said update value.

10. The system of claim 9 wherein said document representation is adapted to visually alter in color tine based on said update value.

11. The system of claim 7 further comprising multiple, distinct tile clusters with adjacent tiles based on said interrelated document data.

12. A method of displaying documents, said method comprising:
obtaining document data having at least two abstraction levels;
representing one of said abstraction levels in a document representation within a a variable display region of a tile having a tile position and tile dimensions;
spatially modifying said tile by depth and a position; and
altering said document representation between one of said at least two abstraction levels based on said tile dimensions.

13. The method of claim 12 further comprising sequencing multiple tiles having a document representation based on interrelated document data.

14. The method of claim 13 wherein said representing step includes representing said document data within a hexagonal tile.

15. The method of claim 14 wherein said altering step includes altering step includes altering said document representation between the natural document and an abbreviated representation.

16. The method of claim 15 wherein said altering step includes altering said document representation based on an abbreviated representation based on at least one of a group consisting of a title, an abstract, a summary, a keyword representation, and combinations thereof.

17. The method of claim 15 further comprising the step of tracking updates to said document data via an update track adapted to measure modifications to said document data.

18. The method of claim 17 further comprising the step of altering said tile dimensions based on said update track.

19. The method of claim 17 further comprising the step of altering a color tint of said variable display region based on said update track.

20. A method of displaying documents, said method comprising:
obtaining document data for multiple documents having at least two abstraction levels;
representing said document data in a document representation within a hexagonal tile having a tile position and tile dimensions;
sequencing said hexagonal tiles based on interrelated document data;
spatially modifying said tile based on a depth value and a position value;
altering said document representation between one of said at least two abstraction levels based on said tile dimensions; and
tracking updates to said document data via an update track adapted to measure modifications to said document data.
